(19) United States
(12) Patent Application Publication
(10) Pub. No.: US 2007/0260728 A1
(43) Pub. Date: Nov. 8, 2007

(54) SYSTEMS AND METHODS FOR GENERATING NETWORK DIAGNOSTIC STATISTICS

(75) Inventor: Gayle L. Noble, Boulder Creek, CA (US)

Correspondence Address: WORKMAN NYDEGGER, 60 EAST SOUTH TEMPLE, 1000 EAGLE GATE TOWER, SALT LAKE CITY, UT, 84111, US

(73) Assignee: FINISAR CORPORATION, Sunnyvale, CA (US)

(21) Appl. No.: 11/744,591

(22) Filed: May 4, 2007

Related U.S. Application Data
(60) Provisional application No. 60/798,525, filed on May 8, 2006.

(51) Int. Cl. G06F 15/173

(52) U.S. Cl. 709/224; 709/223

(57) ABSTRACT

A network diagnostic system may include a statistics module. The statistics module may include a plurality of stages and may include stage-transition code. The stage-transition code may be used to help maintain one or more network diagnostic statistics. The statistics module may be implemented using a network processor unit, and the network processor unit may include a plurality of stages and may include stage-transition code. To help maintain one or more network diagnostic statistics, the statistics module may add and remove entries to a data structure.

### CROSS-REFERENCE TO RELATED APPLICATIONS

This application claims priority to and the benefit of U.S. provisional patent application Ser. No. 60/798,525, which was filed on May 8, 2006 and entitled SYSTEMS AND METHODS FOR GENERATING NETWORK DIAGNOSTIC STATISTICS, the disclosure of which is incorporated by reference in its entirety.

### BACKGROUND OF THE INVENTION

1. Field of the Invention

The present invention generally relates to network diagnostic systems and methods and in particular to systems and methods for generating network diagnostic statistics.

2. Background Technology

Computer and data communications networks continue to proliferate due to declining costs, increasing performance of computer and networking equipment, and increasing demand for communication bandwidth. Communications networks—including wide area networks (“WANs”), local area networks (“LANs”), metropolitan area networks (“MANs”), and storage area networks (“SANS”)—allow increased productivity and use of distributed computers or stations through the sharing of resources, the transfer of voice and data, and the processing of voice, data and related information at the most efficient locations. Moreover, as organizations have recognized the economic benefits of using communications networks, network applications such as electronic mail, voice and data transfer, host access, and shared and distributed databases are increasingly used as a means to increase user productivity. This increased demand, together with the growing number of distributed computing resources, has resulted in a rapid expansion of the number of installed networks.

As the demand for networks has grown, network technology has developed to the point that many different physical configurations presently exist. Examples include Gigabit Ethernet (“GE”), 10 GE, Fiber Distributed Data Interface (“FDDI”), Fibre Channel (“FC”), Synchronous Optical Network (“SONET”) and InfiniBand networks. These networks, and others, typically conform to one of a variety of established standards, or protocols, which set forth rules that govern network access as well as communications between and among the network resources. Typically, such networks utilize different cabling systems, have different characteristic bandwidths and typically transmit data at different speeds. Network bandwidth, in particular, has been the driving consideration behind many advancements in the area of high speed communication systems, methods and devices.

For example, the ever-increasing demand for network bandwidth has resulted in the development of technology that increases the amount of data that can be pushed through a single channel on a network. Advancements in modulation techniques, coding algorithms and error correction have vastly increased the rates at which data can be transmitted across networks. For example, in the past, the highest rate that data could travel across a network was at about one Gigabit per second. This rate has increased to the point where data can travel across Ethernet and SONET networks at rates as high as 10 gigabits per second, or faster.

As communication networks have increased in size, speed and complexity however, they have become increasingly likely to develop a variety of problems that, in practice, have proven difficult to diagnose and resolve. Such problems are of particular concern in light of the continuing demand for high levels of network operational reliability and for increased network capacity.

The problems generally experienced in network communications can take a variety of forms and may occur as a result of a variety of different circumstances. Examples of circumstances, conditions and events that may give rise to network communication problems include the transmission of unnecessarily small frames of information, inefficient or incorrect routing of information, improper network configuration and superfluous network traffic, to name just a few. Such problems are aggravated by the fact that networks are continually changing and evolving due to growth, reconfiguration and introduction of new network topologies and protocols. Moreover, new network interconnection devices and software applications are constantly being introduced and implemented. Circumstances such as these highlight the need for effective, reliable, and flexible diagnostic mechanisms.

Unfortunately, some diagnostic mechanisms may be slower in performing various diagnostic functions on networks, such as generating network diagnostic statistics.

### BRIEF SUMMARY OF EMBODIMENTS OF THE INVENTION

A need therefore exists for systems and methods that eliminate or reduce the disadvantages and problems listed above and/or other disadvantages and problems.

One aspect is a network diagnostic system that may comprise a network processing unit. The network processing unit may include a first stage, a second stage, and stage-transition code. The stage-transition code may be configured to update at least one network diagnostic statistic associated with a first network message received from the first stage.

Another aspect is a network diagnostic system that may comprise a statistics module. The statistics module may be used for maintaining a set of one or more network diagnostic statistics including a first network diagnostic statistic. The statistics module may include a data structure. The statistics module may be configured to receive a network message associated with the first network diagnostic statistic. The statistics module may also be configured to, when the received network message is a first type of network message, add an entry associated with the first network diagnostic statistic to the data structure. The statistics module may also be configured to, when the received network message is a second type of network message and the data structure includes one or more entries associated with the first network diagnostic statistic, remove at least one of the entries. The statistics module may also be configured to, when the received network message is a second type of network message and the data structure does not include any entries associated with the first network diagnostic statistic, alter the first network diagnostic statistic.

Yet another aspect is a method for using stage transition code of a network processor unit. The network processor unit may include a plurality of stages. The method may comprise using the stage transition code of the network processor to update at least one network diagnostic statistic associated with a network message received from one of the plurality of stages.

For purposes of summarizing, some aspects, advantages, and novel features have been described. Of course, it is to be understood that not necessarily all such aspects, advantages, or features will be embodied in any particular embodiment of the invention. Further, embodiments of the invention may comprise aspects, advantages, or features other than those that have been described. Some aspects, advantages, or features of embodiments of the invention may become more fully apparent from the following description and appended claims or may be learned by the practice of embodiments of the invention as set forth in this disclosure.

### BRIEF DESCRIPTION OF THE DRAWINGS

The appended drawings contain figures of preferred embodiments to further clarify the above and other aspects, advantages and features of the present invention. It will be appreciated that these drawings depict only preferred embodiments of the invention and are not intended to limits its scope. The invention will be described and explained with additional specificity and detail through the use of the accompanying drawings in which:

FIG. 1 is a block diagram of an exemplary embodiment of a network diagnostic system;

FIG. 2 is a flowchart illustrating a portion of an exemplary embodiment of a network diagnostic method;

FIG. 3 is a flowchart illustrating a portion of an exemplary embodiment of a network diagnostic method;

FIG. 4 is a flowchart illustrating a portion of an exemplary embodiment of a network diagnostic method;

FIG. 5 is a flowchart illustrating a portion of an exemplary embodiment of a network diagnostic method; and

FIG. 6 is a flowchart illustrating an exemplary embodiment of a network diagnostic method.

### DETAILED DESCRIPTION OF THE PREFERRED EMBODIMENTS

The present invention is generally directed towards network diagnostic systems and methods. The principles of the present invention, however, are not limited to network diagnostic systems and methods. It will be understood that, in light of the present disclosure, the systems and methods disclosed herein can be successfully used in connection with other types of systems and methods.

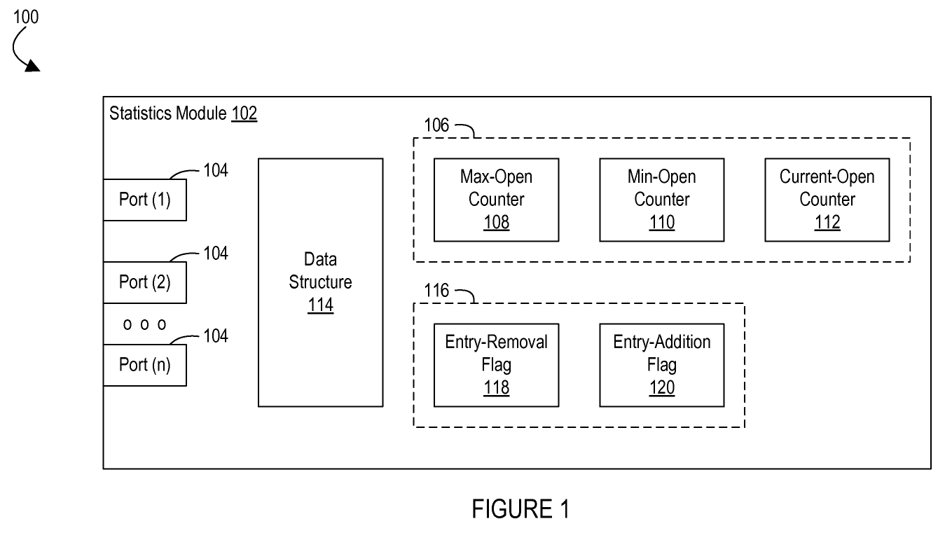

As shown in FIG. 1, a network diagnostic system 100 may include a statistics module 102. The statistics module 102 may include one or more ports 104 via which the statistics module 102 may receive and/or route network messages.

The statistics module 102 is preferably configured to maintain one or more sets 106 of network diagnostic statistics. A set 106 may include a single diagnostic statistic or a plurality of network diagnostic statistics, if desired. As shown in FIG. 1, one exemplary set 106 of network diagnostic statistics may include a max-open counter 108 (indicating the highest number of transactions that were open during a time period), a min-open counter 110 (indicating the lowest number of transactions that were open during a time period), and a current-open counter 112 (indicating the number of transactions that are currently open). It will be appreciated, however, that the statistics module 102 may maintain a max-open counter 108, a min-open counter 110, a current-open counter 112, other suitable network diagnostic statistics, or any combination thereof. Exemplary network diagnostic statistics may include, but are not limited to, counts, sums, averages, standard deviations, and/or other suitable network diagnostic statistics.

The statistics module 102 is preferably configured to maintain one or more sets 106 using network messages received by the statistics module 102. In particular, after receiving a network message, the statistics module 102 may use that network message to maintain at least one set 106 associated with that network message.

As shown below, a network message may be associated with a variety of sets 106 of network diagnostic statistics.

For example, a network message may be received via a port 104, and the statistics module 102 may maintain a set 106 using network messages received via an individual port 104 or via a plurality of ports 104. Thus, the statistics module 102 may maintain a first set 106 using network messages received via a first port 104, a second set 106 using network messages received via a second port 104, and/or a third set 106 using network messages received via any of the first and second ports. If desired, the statistics module 102 may maintain any number of sets 106 for any combination of ports 104. It will be appreciated that a port 104 may be coupled to (and thus used to receive network messages from) a link, a channel, a switch; a hub; all or a portion of a SAN fabric; and/or any other component of a network. Thus, the statistics module 102 may maintain a set 106 using network messages transmitted via an individual link, channel or the like or via a plurality of links, channels or the like.

Also, for example, a network message may be sent from a particular node, and the statistics module 102 may maintain a set 106 using network messages received from a node or from a plurality of nodes. Thus, the statistics module 102 may maintain a first set 106 using network messages sent from a first node, a second set 106 using network messages sent from a second node, and/or a third set 106 using network messages sent from any of the first and second nodes.

Also, for example, a network message may be sent to a particular node, and the statistics module 102 may maintain a set 106 using network messages sent to a node or sent to a plurality of nodes. Thus, the statistics module 102 may maintain a first set 106 using network messages sent to a first node, a second set 106 using network messages sent to a second node, and/or a third set 106 using network messages sent to any of the first and second nodes.

Also, for example, a network message may be communicated between a first node and a second node, and the statistics module 102 may maintain a set 106 using network messages from the communication between the first and second nodes. In one embodiment, the statistics module 102 may maintain a set 106 using network messages from a conversation between an initiator and a target.

To help the statistics module 102 maintain the sets 106 of network diagnostic statistics, the statistics module 102 may include a data structure 114 and one or more sets 116 of flags (such as, an entry-removal flag 118, an entry-addition flag 120, other flags or any combination thereof). In particular, the statistics module 102 may add and remove entries to the data structure 114 to help maintain the sets 106 of network diagnostic statistics, which will be discussed in further detail below. It will be appreciated, however, that the statistics module 102 does not require the data structure 114, the entry-removal flag 118, the entry-addition flag 120, or any sets 116 and that the statistics module 102 may include a variety of other suitable structures to maintain the sets 106 of network diagnostic statistics. It will also be appreciated that the statistics module 102 does not require the addition or removal of entries to any data structure to maintain the sets 106 of network diagnostic statistics.

### Exemplary Methods

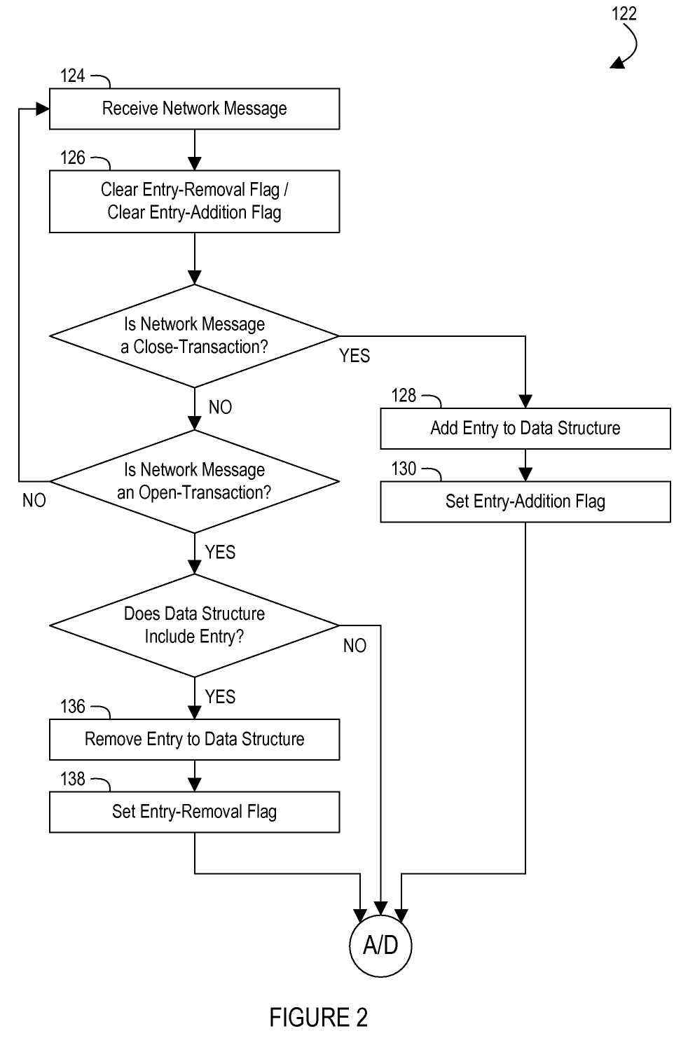

As shown in FIGS. 2-5, the statistics module 102 preferably performs all or at least a portion of a method 122; however, other suitable modules and/or systems may perform the method 122. Further, all or any suitable portion of the method 122 may be performed to provide a useful method 122.

At a block 124 in FIG. 2, the statistics module 102 may receive a network message (such as a packet or other network message), and, at a block 126, the statistics module 102 may clear one or more flags associated with the network message, such as an entry-removal flag 118 and/or an entry-addition flag 120. The statistics module 102 may associate an entry-removal flag 118 and an entry-addition flag 120 for any received network message, if desired.

If the network message received at the block 124 is not a close-transaction network message and is not an open-transaction network message, the statistics module 102 may return to the block 124 to receive another network message.

If the network message received at the block 124 is a close-transaction network message, the statistics module 102 may proceed to a block 128. At the block 128, the statistics module 102 may add an entry to the data structure 114. In further detail, the network message received at the block 124 may be associated with a set 106 of network diagnostic statistics, and the entry may be added to an existing set of one or more entries used to maintain the set 106 or may be added as the first member of a set of one or more entries used to maintain the set 106. For example, in one embodiment, the first entry of a set of entries may comprise a “node,” and one or more subsequent entries of the set of entries may comprise “leaves” linked to the node. Also, for example, in one embodiment, the entries of a set may be elements “pushed” onto a stack.

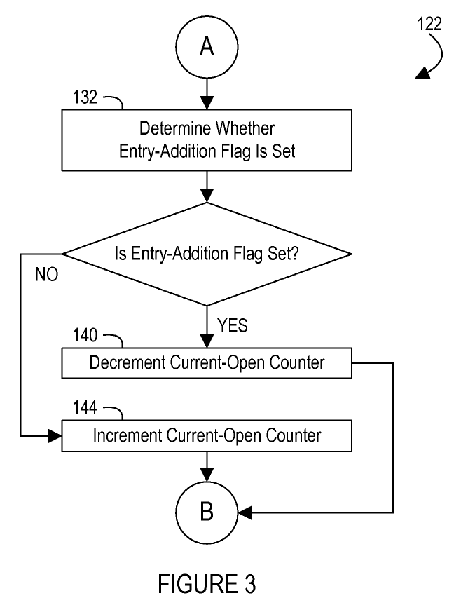

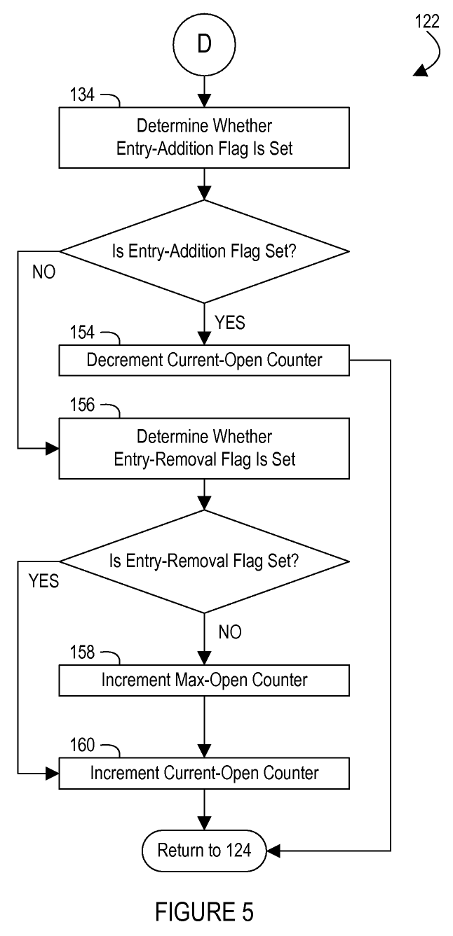

The statistics module 102 may proceed from the block 128 to a block 130. At the block 130, the statistics module 102 may set the entry-addition flag 120 associated with the network message received at the block 124. In one embodiment, the statistics module 102 may proceed from the block 130 to a block 132 (FIG. 3). In another embodiment, the statistics module 102 may proceed from the block 130 to a block 134 (FIG. 5).

If the network message received at the block 124 is an open-transaction network message and the data structure 114 includes an entry, the statistics module 102 may remove the entry from the data structure 114 at a block 136. In further detail, the network message received at the block 124 may be associated with a set 106 of network diagnostic statistics, and the data structure 114 may include a set of one or more entries associated with the set 106 (such as, the entries added at the block 128). Accordingly, the statistics module 102 may remove one of those entries from the set at the block 136. For example, in one embodiment where the first entry of a set of entries may comprise a “node” and one or more subsequent entries of the set of entries may comprise “leaves” linked to the node, the statistics module 102 may remove a leaf (when any such leaves exist) or may remove the node (when no such leaves exist). Also, in one embodiment where the entries of a set may be elements “pushed” onto a stack, the statistics module 102 may “pop” an element off of the stack.

The statistics module 102 may proceed from the block 136 to a block 138. At the block 138, the statistics module 102 may set the entry-removal flag 118 associated with the network message received at the block 124. In one embodiment, the statistics module 102 may proceed from the block 138 to the block 132 (FIG. 3). In another embodiment, the statistics module 102 may proceed from the block 138 to the block 134 (FIG. 5).

If the network message received at the block 124 is an open-transaction network message and the data structure 114 does not include an entry, the statistics module 102 may, in one embodiment, proceed to the block 132 (FIG. 3) or, in another embodiment, may proceed to the block 134 (FIG. 5). In further detail, the network message received at the block 124 may be associated with a set 106 of network diagnostic statistics, and the data structure 114 may include a set of one or more entries associated with the set 106 (such as, the entries added at the block 128). However, if the data structure 114 does not include such a set of one or more entries, the statistics module 102 may proceed to the block 132 (FIG. 3) or the block 134 (FIG. 5).

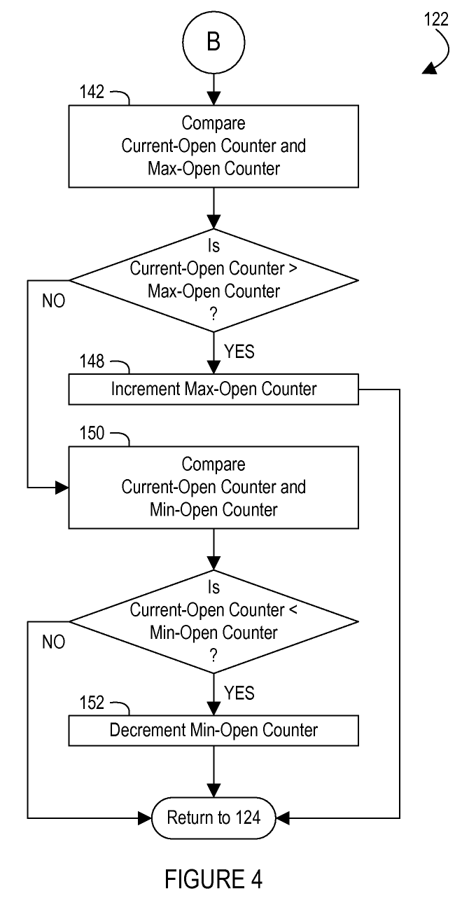

As shown in FIG. 3, at the block 132, the statistics module 102 may determine whether the entry-addition flag 120 associated with the network message received at the block 124 is set. If the entry-addition flag 120 associated with the network message received at the block 124 is set, the statistics module 102 may, at the block 140, decrement a current-open counter 112 associated with the network message and may proceed to a block 142 (FIG. 4). For example, where the network message received at the block 124 is associated with a set 106, the statistics module 102 may decrement a current-open counter 112 of that set 106 at the block 140. If the entry-addition flag 120 associated with the network message received at the block 124 is not set, the statistics module 102 may proceed to a block 144.

At the block 144, the statistics module 102 may increment a current-open counter 112 associated with the network message and may proceed to the block 142 (FIG. 4). For example, where the network message received at the block 124 is associated with a set 106, the statistics module 102 may, at the block 144, increment a current-open counter 112 of that set 106 and may proceed to the block 142 (FIG. 4).

As shown in FIG. 4, at the block 142, the statistics module 102 may compare the current-open counter 112 and the max-open counter 108 that are associated with the network message received at the block 124. For example, where the network message received at the block 124 is associated with a set 106, the statistics module 102 may, at the block 142, compare a current-open counter 112 and a max-open counter 108 of that set 106. If the current-open counter 112 is greater than the max-open counter 108, the statistics module 102 may increment the max-open counter 108 at the block 148 and may return to the block 124 (FIG. 2) to receive another network message. If the current-open counter 112 is not greater than the max-open counter 108, the statistics module 102 may proceed to the block 150.

At the block 150, the statistics module 102 may compare the current-open counter 112 and the min-open counter 110 that are associated with the network message received at the block 124. For example, where the network message received at the block 124 is associated with a set 106, the statistics module 102 may, at the block 150, compare a current-open counter 112 and a min-open counter 110 of that set 106. If the current-open counter 112 is less than the min-open counter 110, the statistics module 102 may decrement the min-open counter 110 at the block 152 and may return to the block 124 (FIG. 2) to receive another network message. If the current-open counter 112 is not less than the min-open counter 110, the statistics module 102 may return to the block 124 (FIG. 2) to receive another network message.

As shown in FIG. 5, at the block 134, the statistics module 102 may determine whether the entry-addition flag 120 associated with the network message received at the block 124 is set.

If the entry-addition flag 120 associated with the network message received at the block 124 is set, the statistics module 102 may, at the block 154, decrement a current-open counter 112 associated with the network message and may return to the block 124 (FIG. 2) to receive another network message. For example, where the network message received at the block 124 is associated with a set 106, the statistics module 102 may, at the block 154, decrement a current-open counter 112 of that set 106.

If the entry-addition flag 120 associated with the network message received at the block 124 is not set, the statistics module 102 may proceed to a block 156.

At the block 156, the statistics module 102 may determine whether the entry-removal flag 118 associated with the network message received at the block 124 is set.

If the entry-removal flag 118 associated with the network message received at the block 124 is not set, the statistics module 102 may increment a max-open counter 108 associated with the network message at the block 158; may increment a current-open counter 112 associated with the network message at the block 160; and may return to the block 124 (FIG. 2) to receive another network message. For example, where the network message received at the block 124 is associated with a set 106, the statistics module 102 may, at the block 154, increment a max-open counter 108 of that set 106 and may, at the block 160, increment a current-open counter 112 of that set.

If the entry-removal flag 118 associated with the network message received at the block 124 is set, the statistics module 102 may increment a current-open counter 112 associated with the network message at the block 160 and may return to the block 124 (FIG. 2). For example, where the network message received at the block 124 is associated with a set 106, the statistics module 102 may, at the block 160, increment a current-open counter 112 of that set.

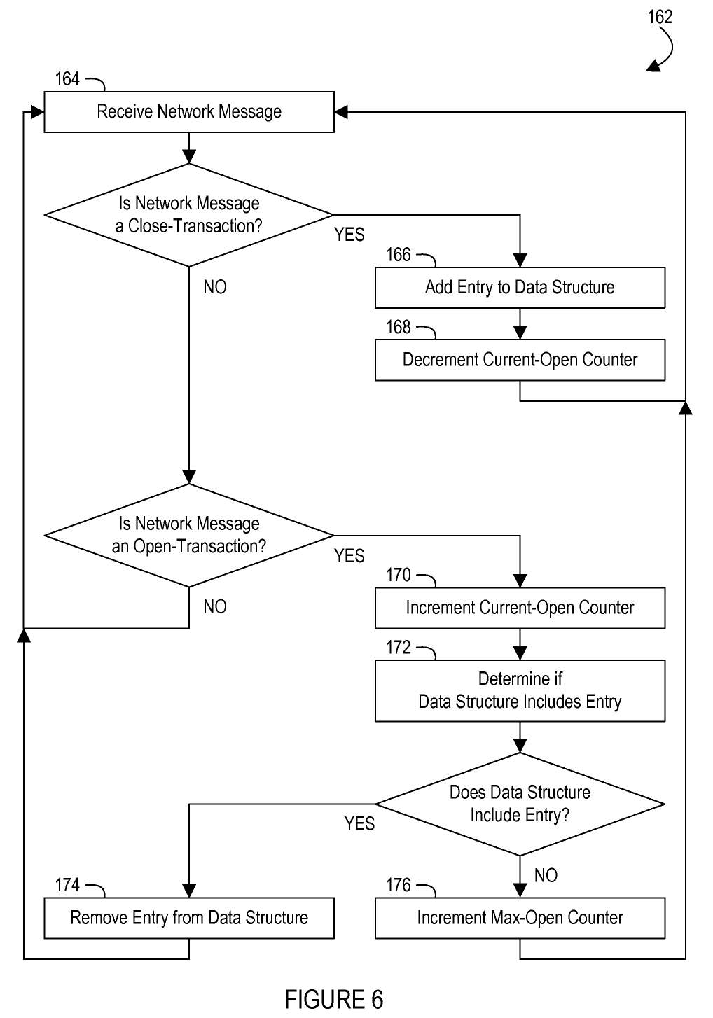

As shown in FIG. 6, the statistics module 102 preferably performs all or at least a portion of a method 162; however, other suitable modules and/or systems may perform the method 162. Further, all or any suitable portion of the method 162 may be performed to provide a useful method 162.

At a block 164 in FIG. 6, the statistics module 102 may receive a network message.

If the network message received at the block 164 is not a close-transaction network message and is not an open-transaction network message, the statistics module 102 may return to the block 164 to receive another network message.

If the network message received at the block 164 is a close-transaction network message, the statistics module 102 may proceed to a block 166. At the block 166, the statistics module 102 may add an entry to the data structure 114. In further detail, the network message received at the block 164 may be associated with a set 106 of network diagnostic statistics, and the entry may be added to an existing set of one or more entries used to maintain the set 106 or may be added as the first member of a set of one or more entries used to maintain the set 106.

The statistics module 102 may proceed from the block 166 to a block 168. At the block 168, the statistics module 102 may decrement a current-open counter 112 associated with the network message and may return to the block 164 to receive another network message. For example, where the network message received at the block 164 is associated with a set 106, the statistics module 102 may decrement a current-open counter 112 of that set 106 at the block 168.

If the network message received at the block 164 is an open-transaction network message, the statistics module 102 may proceed to a block 170. At the block 170, the statistics module 102 may increment a current-open counter 112 associated with the network message and may proceed to a block 172. For example, where the network message received at the block 164 is associated with a set 106, the statistics module 102 may increment a current-open counter 112 of that set 106 at the block 170.

At the block 172, the statistics module 102 may determine if the data structure 114 includes an entry associated with the network message received at the block 164. If the statistics module 102 includes an entry associated with the network message received, the statistics module 102 may proceed to a block 174; and if the statistics module 102 does not include an entry associated with the network message received, the statistics module 102 may proceed to a block 176. In further detail, the network message received at the block 164 may be associated with a set 106 of network diagnostic statistics, and the data structure 114 may include a set of one or more entries associated with the set 106 (such as, the entries added at the block 166). Accordingly, the statistics module 102 may, at the block 172, determine whether the data structure 114 includes the set of one or more entries or not.

At the block 174, the statistics module 102 may remove an entry from the data structure 114 and may return to the block 164 to receive another network message. In further detail, the network message received at the block 164 may be associated with a set 106 of network diagnostic statistics, and the data structure 114 may include a set of one or more entries associated with the set 106 (such as, the entries added at the block 166). Accordingly, the statistics module 102 may remove one of those entries from the set at the block 174.

At the block 176, the statistics module 102 may increment a max-open counter 108 associated with the network message received at the block 164 and may return to the block 164 to receive another network message. For example, where the network message received at the block 164 is associated with a set 106, the statistics module 102 may, at the block 176, increment a max-open counter 108 of that set 106.

### Stages

The statistics module 102 may be configured to receive, route and/or otherwise process network messages. To help the statistics module 102 receive, route and/or otherwise process one or more network messages, the statistics module 102 may include a plurality of stages at which processes may be performed using a received network message. For example, after receiving a network message, the statistics module 102 may perform one or more processes using the network message at a first stage, then one or more processes using the network message at a second stage, then one or more processes using the network message at a third stage, and so forth. The statistics module 102 may include two, three, four, five, six or more stages depending, for example, upon the particular configuration of the statistics module 102.

The statistics module 102 is preferably configured process a plurality of network messages—as they are received—through the various stages. Accordingly, at any given time, some of the received network messages may be at various parts of a first stage, some of the received messages may be at various parts of a second stage, some of the received messages may be at various parts of a third stage, and so forth.

The statistics module 102 may perform at least a portion of the methods 122, 162 at one or more stages of the statistics module 102. For example, the statistics module 102 may perform any combination of one or more of the blocks 126, 128, 130, 136, 138 at one or more stages of the statistics module 102. If desired, any other portions of the methods 122, 162 may be performed at stages of the statistic module. It will be appreciated, however, that the methods 122, 162 need not be performed at any stages of the statistics module 102 and that the statistics module 102 does not require any stages.

The statistics module 102 preferably includes stage-transition code (such as, “kick code”) that is configured to process network messages after completing a particular stage. For example, some commercially available routers and network processor units include a plurality of stages and “kick code” that is used to determine whether a network message is passed from one stage to another stage (and, if so, which stage) or whether the network message need not be passed to another stage because the network message is ready to be routed to a desired destination.

The statistics module 102 may perform at least a portion of the methods 122, 162 in the stage-transition code of the statistics module 102. For example, the statistics module 102 may perform any combination of one or more of the blocks 132, 140, 144, 142, 148, 150, 152, 154, 156, 158, 160, 166, 168, 170, 172, 174, 176 in the stage-transition code of the statistics module 102. If desired, any other portions of the methods 122, 162 may be performed in the stage-transition code.

Preferably, the stage-transition code of the statistics module 102 processes each network message leaving a stage individually. For example, in one embodiment, as a network message leaves a stage, the statistics module 102 may place the network message in a queue, and the stage-transition code associated with that stage may retrieve one network message from the queue at a time to process the network messages individually. Individually processing each network message leaving a stage may advantageously allow the statistics module 102 to maintain a variety of counters (such as, the counters 108, 110, 112) without having to lock the counters. Because the statistics module 102 need not lock the counters, the statistics module 102 may advantageously more quickly maintain the counters. It will be appreciated, however, that the counters may be locked and unlocked depending upon, for example, the particular implementation of the statistics module 102. It will also be appreciated that the methods 122, 162 need not be performed in the stage-transition code of the statistics module and that the statistics module 102 does not require any stage-transition code.

If desired, the statistics module 102 may be implemented using a network processor unit (“NPU”), such as the NP-1c network processor available from EZchip Technologies Inc., which has its headquarters at 900 East Hamilton Avenue, Suite 100, Campbell, Calif. 95008, and has a website at www.ezchip.com. If desired some hardware automation provided by the network processor unit may be leveraged to perform parts of the methods 122, 162. Leveraging this hardware automation may allow the network processor to perform some or all of the methods 122, 162 at a relatively fast speed.

It will be appreciated that some or all of the methods 122, 162 may be performed using suitable hardware automation; however, hardware automation is not required. It will also be appreciated that the statistics module 102 does not require the NP-1c or any other network processor unit.

### Exemplary Ethernet LAN Statistics

As described above, the statistics module 102 may generate a variety of statistics. In some embodiments, the statistics may be used to trigger a bit sequence capture. In some embodiments, statistics may be generated for Ethernet LANs or other networks.

In one embodiment, the Ethernet LAN statistics may include protocol distribution statistics, which may include any combination of the following: the number of packets for a protocol, the percent of all packets which were this protocol, the number of octects (bytes) for this protocol, the percent of all bytes which were this protocol, the percent of the theoretical bandwidth used by this protocol, and/or other like statistics.

In one embodiment, the Ethernet LAN statistics may include a variety of host-specific stats, which may include any combination of the following: the number of frames destined for the host, the number of frames from the host, the number of frames to and from the host, the number of bytes destined for the host, the number of bytes from the host, the number of bytes to and from the host, the number of errors from the host, the number of broadcast frames from the host, the number of multicast frames from the host, the percent of all frames that are destined for the host, the percent of all frames that are from the host, the percent of all frames that are to or from the host, the percent of all bytes that are destined for the host, the percent of all bytes that are from the host, the percent of all bytes that are to or from the host, the percent of the theoretical bandwidth used by traffic destined for the host, the percent of the theoretical bandwidth used by traffic from the host, the percent of the theoretical bandwidth used by traffic to and from the host, the average size in bytes for frames that are destined for the host, the average size in bytes for frames that are from the host, the average size in bytes for all frames to or from the host, and/or other like statistics.

In one embodiment, the Ethernet LAN statistics may include a variety of host-specific, network-layer statistics, such as, for a particular virtual LAN. The host-specific, network-layer statistics may include any combination of: the number of frames in the number of frames out, the number of frames in and out, the number of bytes in, the number of bytes out, the number of bytes in and out, the number of non-unicast frames, the percent of all frames that are destined for the host, the percent of all frames that are from the host, the percent of all frames that are to or from the host, the percent of all bytes that are destined for the host, the percent of all bytes that are from the host, the percent of all bytes that are to or from the host, the percent of the theoretical bandwidth used by traffic destined for the host, the percent of the theoretical bandwidth used by traffic from the host, the percent of the theoretical bandwidth used by traffic to and from the host, the average size in bytes for frames that are destined for the host, the average size in bytes for frames that are from the host, the average size in bytes for all frames to or from the host, and/or other like statistics.

In one embodiment, the Ethernet LAN statistics may include a variety of host-specific, application-layer statistics, such as, for a particular virtual LAN identifier and application protocol. The host-specific, application-layer statistics may include any combination of: the number of frames in the number of frames out, the number of frames in and out, the number of bytes in, the number of bytes out, the number of bytes in and out, the percent of all frames that are destined for the host, the percent of all frames that are from the host, the percent of all frames that are to or from the host, the percent of all bytes that are destined for the host, the percent of all bytes that are from the host, the percent of all bytes that are to or from the host, the percent of the theoretical bandwidth used by traffic destined for the host, the percent of the theoretical bandwidth used by traffic from the host, the percent of the theoretical bandwidth used by traffic to and from the host, the average size in bytes for frames that are destined for the host, the average size in bytes for frames that are from the host, the average size in bytes for all frames to or from the host, and/or other like statistics.

In one embodiment, the Ethernet LAN statistics may include a variety of multi-host statistics, such as, for a pair of hosts. The multi-host statistics may include any combination of the following: the number of frames from a first host to a second host, the number of frames from the second host to the first host, the number of frames between the first host and the second host, the number of bytes from the first host to the second host, the number of bytes from the second host to the first host, the number of bytes between the first host and the second host, the percent of all frames that are from the first host to the second host, the percent of all frames that are from the second host to the first host, the percent of all frames that are the conversation between the first host and the second host, the percent of all bytes that are from the first host to the second host, the percent of all bytes that are from the second host to the first host, the percent of all bytes that are the conversation between the first host and the second host, the percent of the theoretical bandwidth used by data from the first host to the second host, the percent of the theoretical bandwidth used by data from the second host to the first host, the percent of the theoretical bandwidth used by the conversation between the first host and the second host, the average size in bytes for frames from the first host to the second host, the average size in bytes for frames from the second host to the first host, the average size in bytes for all frames between the first host and the second host, the number of errors from the first host to the second host, the number of errors from the second host to the first host, the number of errors between the first host and the second host, and/or other like statistics.

In one embodiment, the Ethernet LAN statistics may include a variety of multi-host, network-layer statistics, such as, for a particular virtual LAN. The multi-host, network-layer statistics may include any combination of the following: the number of frames from a first host to a second host, the number of frames from the second host to the first host, the number of frames between the first host and the second host, the number of bytes from the first host to the second host, the number of bytes from the second host to the first host, the number of bytes between the first host and the second host, the percent of all frames that are from the first host to the second host, the percent of all frames that are from the second host to the first host, the percent of all frames that are the conversation between the first host and the second host, the percent of all bytes that are from the first host to the second host, the percent of all bytes that are from the second host to the first host, the percent of all bytes that are the conversation between the first host and the second host, the percent of the theoretical bandwidth used by data from the first host to the second host, the percent of the theoretical bandwidth used by data from the second host to the first host, the percent of the theoretical bandwidth used by the conversation between the first host and the second host, the average size in bytes for frames from the first host to the second host, the average size in bytes for frames from the second host to the first host, the average size in bytes for all frames between the first host and the second host, and/or other like statistics.

In one embodiment, the Ethernet LAN statistics may include a variety of multi-host, application-layer statistics, such as, for a particular virtual LAN identifier and application protocol. The multi-host, application-layer statistics may include any combination of the following: the number of frames from a first host to a second host, the number of frames from the second host to the first host, the number of frames between the first host and the second host, the number of bytes from the first host to the second host, the number of bytes from the second host to the first host, the number of bytes between the first host and the second host, the percent of all frames that are from the first host to the second host, the percent of all frames that are from the second host to the first host, the percent of all frames that are the conversation between the first host and the second host, the percent of all bytes that are from the first host to the second host, the percent of all bytes that are from the second host to the first host, the percent of all bytes that are the conversation between the first host and the second host, the percent of the theoretical bandwidth used by data from the first host to the second host, the percent of the theoretical bandwidth used by data from the second host to the first host, the percent of the theoretical bandwidth used by the conversation between the first host and the second host, the average size in bytes for frames from the first host to the second host, the average size in bytes for frames from the second host to the first host, the average size in bytes for all frames between the first host and the second host, and/or other like statistics.

In one embodiment, the Ethernet LAN statistics may include a variety of utilization-related statistics, which may include any combination of the following: the number of frames captured, the number of frames received, the number of broadcast frames, the number of multicast frames, the number of unicast frames, the number of bytes received, the percentage of the max theoretical throughput used, and/or other like statistics.

In one embodiment, the Ethernet LAN statistics may include a variety of error-related statistics, which may include any combination of the following: the number of frame errors, the number of CRC alignment errors, the number of undersized frames, the number of oversized frames, the number of frame fragments, the number of jabber frames, the number of collisions, the number of packets dropped, and/or other like statistics.

In one embodiment, the Ethernet LAN statistics may include a variety of frame-size statistics, which may include any combination of the following: the total number of frames, the total number of bytes, the number of undersize frames, the percent of all frames that are undersized, the number of frames 64 bytes long, the percent of all frames that are 64 bytes long, the number of frames 65-127 bytes long, the percent of all frames that are 65-127 bytes long, the number of frames 128-255 bytes long, the percent of all frames which are 128-255 bytes long, the number of frames 256-511 bytes long, the percent of all frames that are 256-511 bytes long, the number of frames 512-1023 bytes long, the percent of all frames that are 512-1023 bytes long, the number of frames 1024-1518 bytes long, the percent of all frames that are 1024-1518 bytes long, the number of oversize frames, the percent of all frames that are oversized, the average size in bytes for all frames, and/or other like statistics.

In one embodiment, the statistics may include a variety of other host-specific, application-layer statistics, such as, for a particular application protocol. These host-specific, application-layer statistics may include a minimum response time for a host, a maximum response time for a host, an average response time for a host, a total response time for a host, a number of connections to the host for a particular application protocol, and/or other like statistics.

Of course, any of the Ethernet LAN statistics may be used for any suitable type of network other than a LAN using any suitable protocol other than Ethernet.

### Exemplary SAN Statistics

As described above, the statistics module 102 may generate a variety of statistics. In some embodiments, the statistics may be used to trigger a bit sequence capture. In some embodiments, statistics may be generated for SANs.

In one embodiment, the SAN statistics may include a variety of Fibre Channel link metrics, which may include any combination of the following: the total number of frames of any type per second, the total megabytes of frame payload data per second (which may exclude the SOF, Header, CRC, and EOF portions of the frame), the total number of SCSI frames per second (which may include SCSI Command, Transfer Ready, Data and Status frames), the total megabytes of SCSI frame payload data per second (which may include SCSI Command, Transfer Ready, Data and Status frames, but may exclude the SOF, Header, CRC or EOF), the total number of Fibre Channel management frames per second (which may include Extended Link Services or ELS, Basic Link Services or BLS, Fibre Channel Services or FCS, Link Control or LC, and Fabric Frames or SOF(f)), the total megabytes of FC Management frame payload data per second (which may include ELS, BLS, FCS, LC, and SOF(f), but may exclude the SOF, Header, CRC or EOF), the total number of Non-Management and Non-SCSI frames per second, the total megabytes of Non-Management and Non-SCSI frame payload data per second (which may not include the SOF, Header, CRC or EOF), total application data frames per second (which may include solicited and unsolicited data frames), total megabytes of application payload data per second (which may include the payload of solicited and unsolicited data frames), the percentage of total theoretical bus capacity consumed by the payload bytes, the percentage of total theoretical bus capacity consumed by Fibre Channel management frames, the percentage of total theoretical bus capacity consumed by the SCSI frame payload bytes, the percentage of total theoretical bus capacity consumed by the Non-SCSI and Non-Management frame payload bytes, and/or other like statistics.

In one embodiment, the SAN statistics may include a variety of Fibre Channel link event statistics, which may include any combination of the following: the number of times a link has transitioned into a Loss of Sync state in an interval, the number of times a link has transitioned to a Loss of Signal state in an interval, the number of primitive sequences of LIP events (e.g., when a LIP event reinitializes the FC loop and thus cancels all outstanding I/O's), the number of primitive sequences of NOS and OLS events (e.g., when a NOS/OLS event reinitializes the FC link and thus cancels all outstanding I/O's), the number of Fibre Channel Extended Link Services Frames (such as, LOGO, PLOGI, ACC, and the like) in an interval, the number of Fibre Channel Services Frames (such as, Directory Server Management and FC-AL Management) in an interval, the number of Fabric Frames (such as, frames that begin with the SOF(f) primitive) in an interval, the number of Basic Link Services Frames (such as, ABTS, BA_ACC, BA_RJT, and the like) in an interval, the number of Link Control Frames (which may include P_RJT, F_RJT, F_BSY, and may exclude ACK) in an interval, the number of times a link has returned to an Idle state after any LOS, LOSIG, LIP or NOS/OLS events, the number of SCSI Check Condition Status Frames in an interval, the number of SCSI Bad Status Frames (which may include QueueFull, Busy, Condition Met, and the like; but may exclude SCSI Check Condition Status Frames) in an interval, the number of SCSI Task Management Frames (such as, Target Reset, LUN Reset, Clear ACA, and the like) in an interval, the number of FC Code Violations (such as, a bit error or a disparity error that occurred in a Fibre Channel word) in an interval, framing errors that may occur on any link with media or transmission problems (such as, bad or missing CRC; bad or missing SOF/EOF values; improperly truncated frames, such as, jabber or runt frames; EOFa, EOFni, and EOFdti frames; and the like), and/or other like statistics.

In one embodiment, the SAN statistics may include a variety of Fibre Channel link group statistics, which may include any combination of the following: the number of Login type frames (such as, FLOGI, PLOGI, PRLI, ADISC, PDISC, and FDISC frames) in an interval, the number of Logout type frames (such as, LOGO, PRLO, and TPRLO frames) in an interval, the number of ABTS frames in an interval, the number of Notification type frames (such as, FAN and RSCN frames) in an interval, the number of Reject type frames (such as, LS_RJT, BA_RJT, P_RJT, and F_RJT frames) in an interval, the number of Busy type frames (such as, P_BSY and F_BSY frames) in an interval, the number of Accept type frames (such as, BA_ACC and ACC frames) in an interval, the number of Loop Initialization frames (such as, LISM, LIFA, LIPA, LIHA, LISA, LIRP, and LILP frames) in an interval, and/or other like statistics.

In one embodiment, the SAN statistics may include a variety of SCSI link pending exchange statistics, which may include any combination of the following: the number of exchanges that have been opened, but not closed in an interval; the maximum number of exchanges open at one time during an interval, and/or other like statistics. In one embodiment, the SAN statistics may include a variety of initiator-target/LUN statistics, such as, for conversations between a given initiator and a given SCSI target and/or Logical Unit Number (collectively ITL). The initiator-target/LUN statistics may include any combination of the following: the amount of overall bus capacity utilized by SCSI exchanges between the specified ITL, the number of frames per second used by SCSI exchanges between the specified ITL, the frames/sec metric for the specified ITL expressed as a percentage of all frames sent this second, the number of megabytes of frame payload sent per second between the specified ITL (which may exclude the SOF, Header, CRC or EOF), the MB/sec metric for the specified ITL expressed as a percentage of all MB sent this second, the number of SCSI Task Management Frames (such as, Target Reset, LUN Reset, Clear ACA, and the like) for the specified ITL in an interval, the number of SCSI Bad Status Frames (which may include QueueFull, Busy, Condition Met, but may exclude SCSI Check Condition Status Frames) for the specified ITL in an interval, the number of SCSI Check Condition Status Frames for this ITL in an interval, the number of SCSI exchanges aborted during this interval, and/or other like statistics.

In one embodiment, the SAN statistics may include a variety of initiator-target/LUN statistics for a storage device, which may include any combination of the following: the total amount of elapsed time from the SCSI Read Command to the First Data for all exchanges for a specified ITL that completed in an interval, the average amount of elapsed time from the SCSI Read Command to the First Data for all exchanges for a specified ITL that completed in an interval, the minimum amount of elapsed time from the SCSI Read Command to the First Data for all exchanges for a specified ITL that completed in an interval, the maximum amount of elapsed time from the SCSI Read Command to the First Data for all exchanges for a specified ITL that completed in an interval, and/or other like statistics.

In one embodiment, the SAN statistics may include a variety of initiator-target/LUN statistics for various types of exchanges, such as, a read exchange, a write exchange, or other exchange. The ITL exchange statistics may include any combination of the following: the total number of frames per second used by the exchanges between the specified ITL, the total number of megabytes per second used by the exchanges between the specified ITL (which may include the SOF, Header, CRC or EOF), the number of commands issued for the specified ITL in an interval, the number of commands completed for the specified ITL in an interval, the total amount of elapsed time for the SCSI exchanges for the specified ITL that completed in an interval, the average amount of elapsed time per SCSI exchange for the specified ITL that completed in an interval, the minimum amount of elapsed time per SCSI exchange for the specified ITL that completed in this interval, the maximum amount of elapsed time per SCSI exchange for the specified ITL that completed in an interval, the minimum number of data bytes requested for any SCSI exchange for the specified ITL that completed in an interval, the maximum number of data bytes requested for any SCSI exchange for the specified ITL that completed in an interval, and/or other like statistics.

In one embodiment, the SAN statistics may include a variety of SCSI link pending exchange statistics for a specified, which may include any combination of the following: the number of exchanges that have been opened, but not closed in an interval; the maximum number of exchanges open at one time during an interval, and/or other like statistics.

In one embodiment, the SAN statistics may include a variety of SCSI status metrics that indicate one or more of the following: a SCSI status value associated with a frame, one or more sense codes associated with a frame, a timestamp indicating when the frame was observed, an ITL value, and any other suitable information.

In one embodiment, the SAN statistics may include any of a variety of vSAN statistics for at least one vSAN.

Of course, any of the SAN statistics may be used for any suitable type of network other than a SAN or vSAN using any suitable protocol other than Fibre Channel.

### Exemplary Operating and Computing Environments

The methods and systems described above can be implemented using software, hardware, or both hardware and software. For example, the software may advantageously be configured to reside on an addressable storage medium and be configured to execute on one or more processors. Thus, software, hardware, or both may include, by way of example, any suitable module, such as software components, object-oriented software components, class components and task components, processes, functions, attributes, procedures, subroutines, segments of program code, drivers, firmware, microcode, circuitry, data, databases, data structures, tables, arrays, variables, field programmable gate arrays (“FPGA”), a field programmable logic arrays (“FPLAs”), a programmable logic array (“PLAs”), any programmable logic device, application-specific integrated circuits (“ASICs”), controllers, computers, and firmware to implement those methods and systems described above. The functionality provided for in the software, hardware, or both may be combined into fewer components or further separated into additional components. Additionally, the components may advantageously be implemented to execute on one or more computing devices. As used herein, “computing device” is a broad term and is used in its ordinary meaning and includes, but is not limited to, devices such as, personal computers, desktop computers, laptop computers, palmtop computers, a general purpose computer, a special purpose computer, mobile telephones, personal digital assistants (PDAs), Internet terminals, multi-processor systems, hand-held computing devices, portable computing devices, microprocessor-based consumer electronics, programmable consumer electronics, network PCs, minicomputers, mainframe computers, computing devices that may generate data, computing devices that may have the need for storing data, and the like.

Also, one or more software modules, one or more hardware modules, or both may comprise a means for performing some or all of any of the methods described herein. Further, one or more software modules, one or more hardware modules, or both may comprise a means for implementing any other functionality or features described herein.

Embodiments within the scope of the present invention also include computer-readable media for carrying or having computer-executable instructions or data structures stored thereon. Such computer-readable media can be any available media that can be accessed by a computing device. By way of example, and not limitation, such computer-readable media can comprise any storage device or any other medium which can be used to carry or store desired program code means in the form of computer-executable instructions or data structures and which can be accessed by a computing device.

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a computing device to perform a certain function or group of functions. Data structures include, for example, data frames, data packets, or other defined or formatted sets of data having fields that contain information that facilitates the performance of useful methods and operations. Computer-executable instructions and data structures can be stored or transmitted on computer-readable media, including the examples presented above.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A network diagnostic system comprising:
a network processor unit including:
a first stage;
a second stage; and
stage transition code configured to update at least one network diagnostic statistic associated with a network message received from the first stage.

2. The network diagnostic system as in claim 1, wherein the at least one network diagnostic statistic comprises a count.

3. The network diagnostic system as in claim 2, wherein the count indicates a number of open transactions.

4. The network diagnostic system as in claim 2, wherein the count indicates the highest number of transactions open during a time period.

5. The network diagnostic system as in claim 2, wherein the count indicates the lowest number of transactions open during a time period.

6. The network diagnostic system as in claim 1, wherein the network processor unit further includes a queue via which the stage transition code receives network messages from the first stage.

7. The network diagnostic system as in claim 1, wherein the network message is a packet.

8. A network diagnostic system comprising:
a statistics module for maintaining a set of one or more network diagnostic statistics including a first network diagnostic statistic, the statistics module including a data structure;
the statistics module configured to receive a network message associated with the first network diagnostic statistic; to, when the received network message is a first type of network message, add an entry associated with the first network diagnostic statistic to the data structure; to, when the received network message is a second type of network message and the data structure includes one or more entries associated with the first network diagnostic statistic, remove at least one of the entries; and to, when the received network message is a second type of network message and the data structure does not include any entries associated with the first network diagnostic statistic, alter the first network diagnostic statistic.

9. The network diagnostic system as in claim 8, wherein the first type of network message is a close-transaction network message; and wherein the second type of network message is an open-transaction network message.

10. The network diagnostic system as in claim 8, wherein the first network diagnostic statistic is a count indicating a number of open transactions.

11. The network diagnostic system as in claim 10, wherein the statistics module is configured to alter the first network diagnostic statistic by incrementing the count.

12. The network diagnostic system as in claim 8, wherein the first network diagnostic statistic is a count indicating the highest number of transactions open during a time period.

13. The network diagnostic system as in claim 12, wherein the statistics module is configured to alter the first network diagnostic statistic by incrementing the count.

14. The network diagnostic system as in claim 8, wherein the network message is a packet.

15. A method for using stage transition code of a network processor unit, the network processor unit including a plurality of stages, the method comprising:
using the stage transition code of the network processor to update at least one network diagnostic statistic associated with a network message received from one of the plurality of stages.

16. The method as in claim 15, wherein the at least one network diagnostic statistic comprises a count.

17. The method as in claim 16, wherein the count indicates a number of open transactions.

18. The method as in claim 16, wherein the count indicates the highest number of transactions open during a time period.

19. The method as in claim 16, wherein the count indicates the lowest number of transactions open during a time period.

20. The method as in claim 15, wherein the network processor unit further includes a queue via which the stage transition code receives network messages from the first stage.

21. The method as in claim 15, wherein the network message is a packet.
